(19) United States
(12) Patent Application Publication
(10) Pub. No.: US 2013/0264258 A1
(43) Pub. Date: Oct. 10, 2013

(54) STORMWATER TREATMENT DEVICE

(71) Applicant: JENSEN ENTERPRISES, INC. dba JENSEN PRECAST, Sparks, NV (US)

(72) Inventors: Ronald J. Anderson, Sparks, NV (US); Ryan Spreeman, Sparks, NV (US)

(21) Appl. No.: 13/801,257

(22) Filed: Mar. 13, 2013

Related U.S. Application Data
(60) Provisional application No. 61/616,792, filed on Mar. 28, 2012.

(51) Int. Cl. C02F 1/00

(52) U.S. Cl. CPC C02F 1/006
USPC 210/170.03

(57) ABSTRACT

A stormwater treatment vault has a body defining a top surface, a bottom surface, a first side, a second side opposite the first side, and an interior space. A first baffle and a second baffle define a first, second, and third section within the interior space. The vault has an inlet in the first section and an outlet in the third section.

### CROSS-REFERENCE TO RELATED APPLICATIONS

Any and all applications for which a foreign or domestic priority claim is identified in the Application Data Sheet as filed with the present application, are hereby incorporated by reference under 37 CFR 1.57.

### BACKGROUND

1. Field of the Disclosure

The present disclosure relates generally to devices for treatment of stormwater runoff and minimization of pollutant remobilization.

2. Description of the Related Art

Many varieties of stormwater treatment devices exist, providing a variety of functional characteristics. However, such devices and certain components thereof have various limitations and disadvantages.

### SUMMARY OF THE DISCLOSURE

A stormwater treatment device can be positioned and installed near the site of stormwater runoff or can be installed in other positions within a water system. A stormwater treatment device can be installed during the construction of a storm drain or in some embodiments it can be installed into an existing storm drain or water flow path.

Various embodiments of stormwater treatment devices described herein can provide a variety of different treatment functions. In some embodiments, stormwater treatment devices can have different features designed to trap different types of contaminants as water flows through the device. For example, in some embodiments a stormwater treatment device can have features designed to remove buoyant debris, debris of neutral buoyancy, debris that sinks, large particulates, and/or fine particulates. The device can be accessed and the contaminants can be removed.

In some embodiments, a stormwater treatment vault for receiving water from a surface draining area can include a body defining a top surface, a bottom surface, a first side on one end of a length of the vault, a second side on an opposite end of the length, and an interior space. In some embodiments the body can include a base and a top. The vault can also include a first baffle attached to the top surface and the first baffle can extend across a width of the interior space. The vault can have a first gap between a bottom of the first baffle and the bottom surface of the vault. The vault can further include a second baffle attached to the bottom surface of the vault and offset from the first baffle, and the second baffle can extend across the width of the interior space. The vault can have a second gap between a top of the second baffle and the top surface of the vault. In some embodiments, the top of the second baffle can be above the bottom of the first baffle.

The stormwater treatment vault can also include a first vault section between the first side and the first baffle, and the first vault section can include a vault inlet with a top edge of the vault inlet positioned above the top of the second baffle. The stormwater treatment vault can also include a second vault section between the first baffle and the second baffle, a third vault section between the second baffle and the second side, and a flow conduit positioned within the third vault section and connected to a vault outlet. The flow conduit can include a flow conduit inlet with a filter, the flow conduit inlet separated from the bottom surface of the vault and positioned below the vault outlet and below the top of the second baffle. In some embodiments, a section of the flow conduit can be between the flow conduit inlet and the bottom surface of the vault.

In some embodiments, the stormwater treatment vault can include a scum baffle offset from and attached to the second baffle on a side of the second baffle facing the first baffle, the scum baffle including a top end above the top of the second baffle and a bottom end below the top of the second baffle. In some embodiments, a bottom end of the vault outlet can be positioned below the top end of the scum baffle.

In some embodiments, a stormwater treatment vault for receiving water from a surface draining area can include a body defining a top surface, a bottom surface, a first side on one end of a length of the vault, and a second side on an opposite end of the length. The vault can have a first section between the first side and a first baffle attached to the top surface, the first baffle extending across a width of the vault and extending toward but not reaching the bottom surface of the vault, the first section including a vault inlet.

In some embodiments, the vault can also include a second section between the first baffle and a second baffle attached to the bottom surface, the second baffle extending across the width of the vault and extending toward but not reaching the top surface of the vault, wherein a top of the second baffle is above a bottom of the first baffle and below the vault inlet. In some embodiments, the vault can include a third section between the second baffle and the second side and a vault outlet positioned in the third section. A v-notch weir can be attached to the bottom of the first baffle.

### BRIEF DESCRIPTION OF THE DRAWINGS

FIG. 1 is a cross sectional side view of a stormwater treatment device.

FIG. 2 is a cross sectional top view of a stormwater treatment device.

FIG. 3 is a cross sectional end view of a stormwater treatment device, taken along the line 3-3 of FIG. 2.

FIG. 4 is a cross sectional end view of a stormwater treatment device, taken along the line 4-4 of FIG. 2.

FIG. 5 is a detailed image of a baffle, weir plate, and scum baffle taken from FIG. 1.

### DETAILED DESCRIPTION OF THE PREFERRED EMBODIMENT

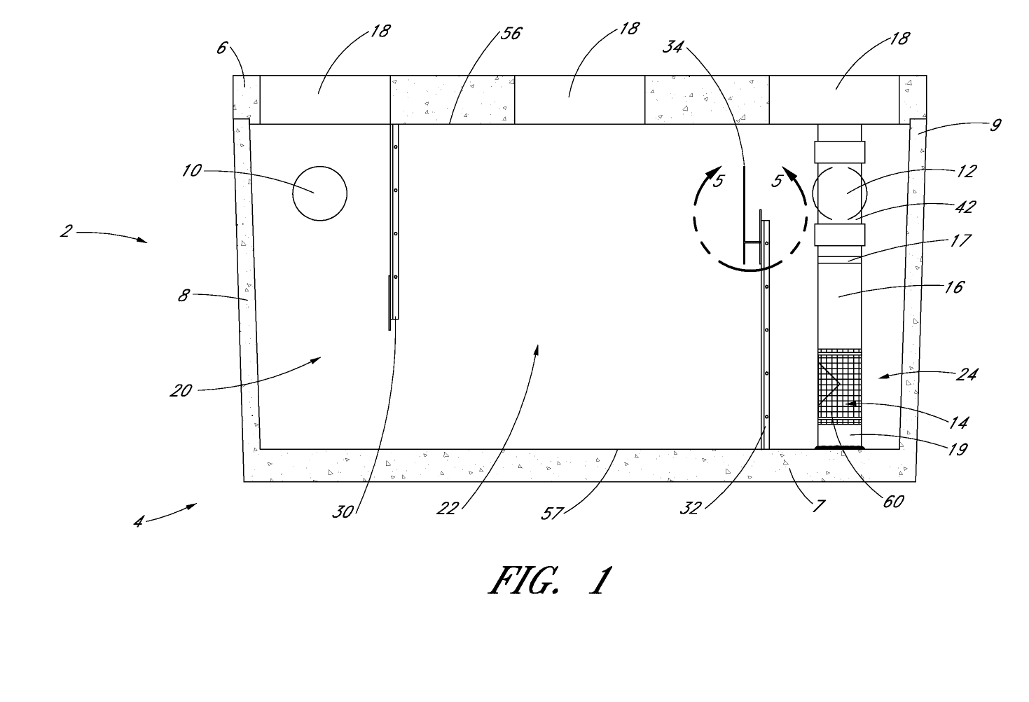

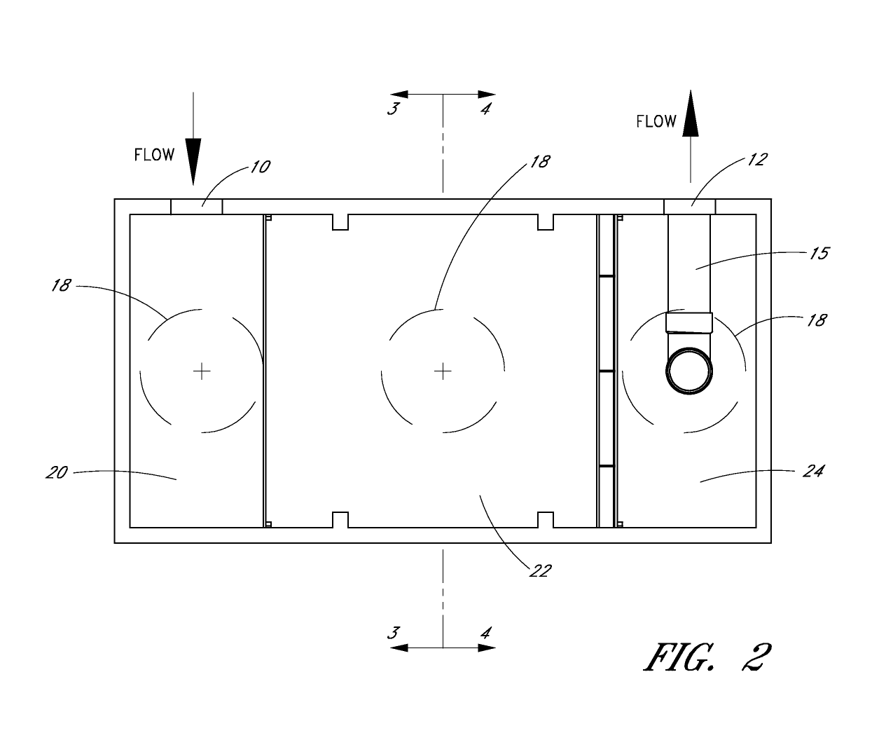

Referring to FIG. 1, a stormwater treatment device such as a dynamic settling clarifier vault 2 can comprise a vault base 4 and a top 6. The device can be positioned and installed near the site of stormwater runoff, but can also be placed in other positions within a water system and can function as a stormwater treatment system. Both the vault base and top are desirably formed of precast concrete, although in some embodiments they can be formed of other materials. The vault can comprise a plurality of chambers, and desirably comprises at least a first chamber 20, a second chamber 22, and a third chamber 24 spaced laterally across the vault, as can be most easily seen in FIG. 2, a top view of a stormwater treatment device. In some embodiments, the device can have two chambers or more than three chambers. The chambers are all desirably in fluid communication with each other, such that water can pass through the vault from chamber to chamber. As discussed in more detail below, the chambers are desirably configured such that as water flows from one chamber to the next, at least some portion of contaminants or debris within the water will collect and remain within each chamber.

The first chamber 20 is desirably defined by the space between a first wall 8 of the vault base and a first baffle 30 that is connected to and extends downward from a lower surface 56 of the top 6. The first baffle desirably extends across the width of the vault but does not extend all the way to the bottom, thereby allowing water to pass into the second chamber through a space beneath the first baffle but above the bottom 7 of the vault. Because the baffle desirably extends across the width of the vault, water desirably does not flow to the sides of the baffle.

The second chamber 22 is desirably defined by the space between the first baffle 30 and the second baffle 32, which desirably extends upward from a top surface 57 of the bottom 7 of the vault. Like the first baffle, the second baffle desirably extends across the full width of the vault, but does not extend all the way to the top 6, thereby allowing fluid to flow from the second chamber to the third chamber through a space above the top of the second baffle but below the top 6 of the vault. Because the second baffle desirably extends across the width of the vault, water desirably does not flow to the side of the second baffle. The third chamber 24 is desirably defined by the space between the second baffle 32 and a second wall 9 of the vault, the second wall positioned opposite the first wall.

The first and second baffles are desirably generally perpendicular to the top 6 and the bottom 7 of the vault and generally parallel to each other. In some embodiments, however, the first and second baffles extend from the top and bottom of the vault, respectively, at an angle that is less than 90°. In some embodiments, the first and second baffles extend from the top and bottom of the vault, respectively, at angles less than 90° but at the same angle such that the first and second baffles remain parallel to each other. In further embodiments, the first and second baffles can extend from the top and bottom of the vault, respectively, at different angles from each other such that the first and second baffles are not substantially parallel to each other. In some embodiments, the device can comprise more than two baffles, which can define more than three separate chambers.

Water desirably enters the vault into the first chamber through inlet 10. The inlet 10 is desirably positioned within a top region of the vault, and at least a top edge of the inlet can be above the top surface of the second baffle 32. In some embodiments the inlet can be lower, but the inlet is desirably above a bottom edge of the first baffle 30. Once it is first filled with water, the vault desirably maintains a level of water within the first and second chambers at least equal in height to the top surface of the second baffle. The vertical position of the outlet is desirably at least slightly below the inlet, although in some embodiments it can be at approximately the same level as the inlet or above the inlet. In some embodiments, positioning the outlet approximately at or slightly below the level of the inlet can allow for the vault to be retrofitted into an existing storm drain or water flow path, or designed for use with a storm drain or other flow path where a large drop in the level of the flow path is undesired.

As water enters the vault at inlet 10, water will traverse the vault from the first chamber to the second chamber to the third chamber. The second baffle 32 desirably extends upward to at least a bottom edge 42 of the outlet 12, such that water must spill over the second baffle 32 in order to reach the third chamber 24, although in some embodiments the top surface of the second baffle can be below the bottom edge 42 of the outlet. The first baffle 30 desirably extends downward at least to the upper edge of the second baffle 32, such that the bottom edge of the first baffle will be completely submerged when water passes through the vault.

When the level of the water in the device—or at least within the first and second chambers—is above the bottom edge of the first baffle 30, buoyant contaminants and debris that enter the vault will generally not pass into the second chamber 22 but remain floating on the surface of the water within the first chamber 20. Water that enters the second chamber will pass below the bottom edge of the first baffle 30, and will need to rise to pass over the second baffle 32 into the third chamber 24. As the water rises, gravity will tend to pull contaminants or debris that have a specific gravity greater than water towards the bottom of the second chamber, where they will desirably collect.

In some embodiments, the dynamic settling clarifier vault can comprise a flow conduit, such as an outlet pipe 16, positioned within the third chamber 24 and connected to the vault outlet 12. In some embodiments the outlet pipe 16 can connect directly to the vault outlet 12, and in some embodiments it can connect through a connection conduit, such as connecting pipe 15, visible in FIG. 2. The outlet pipe 16 is desirably substantially vertical but in some embodiments can be angled or comprise different sections with different orientations. The outlet pipe 16 can comprise a pipe inlet 14, desirably positioned a distance above and separated from the bottom 7 of the vault. In some embodiments, the outlet pipe can connect to the bottom of the vault, and a section 19 of the outlet pipe can join the bottom of the vault to the pipe inlet 14.

In some embodiments, the pipe inlet can comprise a filter, such as a mesh or screen 60. As water passes into the pipe through the pipe inlet 14, the screen can filter out particles that were not caught in the first or second chambers. Further, as the water moves from the top of the second baffle 32 to the pipe inlet 14, any remaining nonbuoyant debris or contaminants will tend toward the bottom of the vault and can desirably collect in the vertical space between the inlet 14 and the bottom of the vault. In some embodiments, the pipe 16 can comprise an orifice plate 17 positioned within the pipe 16. The orifice plate can comprise a central hole smaller than the internal diameter of the pipe. The size of the central hole can be selected to control the flow of water and restrict large flows of water.

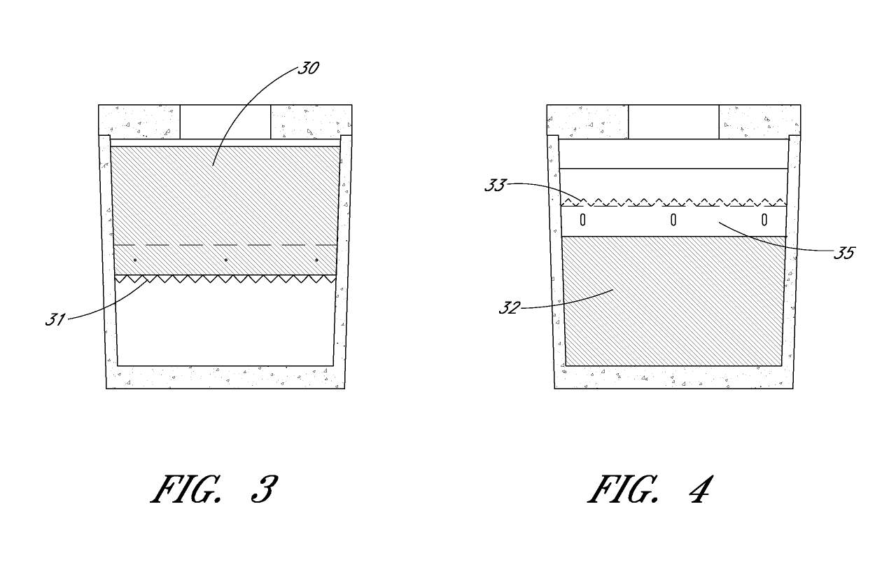

As illustrated in FIG. 3, in some embodiments, the first baffle 30 can comprise an angled weir, such as a v-notch weir 31, along its bottom edge. A v-notch weir can be used to capture contaminants that might otherwise flow past the baffle. V-notch weirs are typically attached to a surface that has water spilling over it, but when attached to a submerged surface, such as the first baffle, they can help collect or catch semi-buoyant or neutral debris or contaminants that would otherwise pass into the second chamber 22. For example, debris such as a plastic bag, a wrapper, or bits of paper, can catch on the v-notch weir 31. A v-notch weir also desirably helps distribute the flow of water as it flows past the baffle.

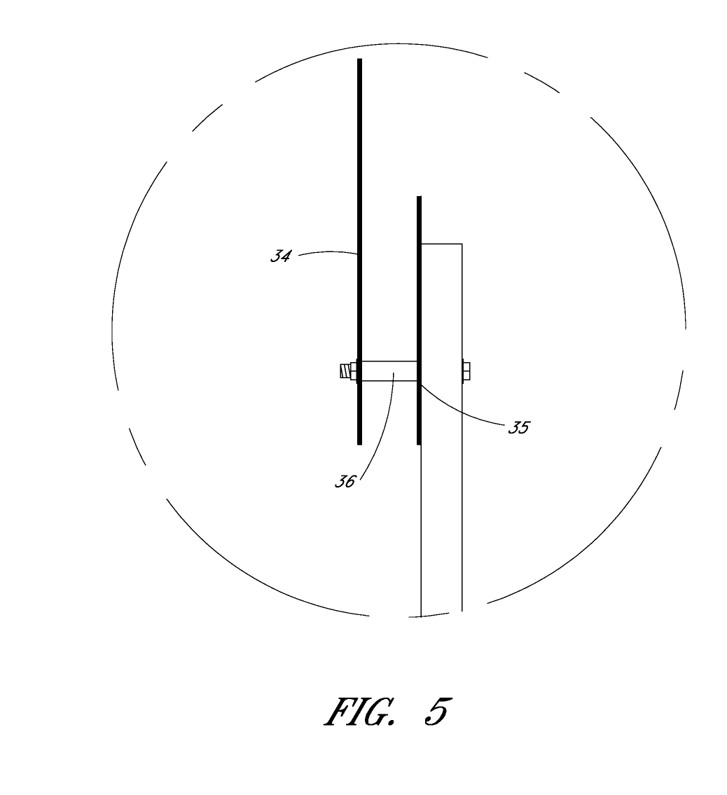

In some embodiments, the second baffle can also comprise an angled weir, such as a v-notch weir 33, as illustrated in FIG. 4. Both baffles are desirably formed of PVC or other plastic material, but in some embodiments, one or more of the baffles can be formed of a metal or other material. In some embodiments, a v-notch weir 31, 33 can be formed separately from the baffle as part of a weir plate 35, which can be bolted or otherwise attached to the baffle.

In some embodiments, the second baffle 32 or any baffle that extends upward from the bottom of the vault can comprise a scum baffle or curb 34 that is desirably attached to and offset from the v-notch weir 33 or the top of the baffle, as illustrated by FIG. 5. The curb 34 desirably extends across the full width of the vault. As illustrated by FIG. 5, the curb is attached by one or more bolts 36 to the baffle 32. The bottom of the curb is desirably substantially even with the bottom of the weir plate 35, although in some embodiments it can be below or above the bottom of the weir plate. The top of the curb desirably extends above the top of the v-notch weir 33 or the baffle 32 if it does not have a v-notch weir. The top of the curb also desirably extends above the level of water within the vault, while the bottom of the curb is desirably below the water level. This allows the curb to act as an additional filter, because water that passes to the third chamber must pass into the gap between the curb and weir plate 35 or baffle 32 before passing over the v-notch weir 33 or baffle 32. Buoyant contaminants or debris that may get into the second chamber will desirably rise to the top of the water level in the second chamber before reaching the curb. The contaminants or debris will desirably remain in the second chamber, unable to sink to be able to pass between the curb and the weir plate. Additionally, some buoyant contaminants or debris may not fit between the curb and the weir plate.

Returning to FIGS. 1 and 2, a stormwater treatment device may need to be periodically maintained to remove contaminants that have collected within the device. The top 6 desirably comprises at least one access port 18, which can facilitate vault maintenance and access. Desirably, the top 6 has one access port for each chamber within the vault 2. This can allow separate access to each chamber to be able to remove accumulated debris or contaminants.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of skill in the art based upon this disclosure. It is also contemplated that various combinations or sub-combinations of the specific features and aspects of the embodiments may be made and still fall within the scope of the invention. Accordingly, it should be understood that various features and aspects of the disclosed embodiments can be combined with or substituted for one another in order to form varying modes of the disclosed invention. Thus, it is intended that the scope of the present invention herein disclosed should not be limited by the particular disclosed embodiments described above, but should be determined only by a fair reading of the claims that follow.

Similarly, this method of disclosure is not to be interpreted as reflecting an intention that any claim require more features than are expressly recited in that claim. Rather, as the following claims reflect, inventive aspects lie in a combination of fewer than all features of any single foregoing disclosed embodiment. Thus, the claims following the Detailed Description are hereby expressly incorporated into this Detailed Description, with each claim standing on its own as a separate embodiment.

What is claimed is:

1. A stormwater treatment vault for receiving water from a surface draining area, the vault comprising:
a body defining a top surface, a bottom surface, a first side on one end of a length of the vault, a second side on an opposite end of the length, and an interior space;
a first baffle attached to the top surface, the first baffle extending across a width of the interior space;
a first gap between a bottom of the first baffle and the bottom surface of the vault;
a second baffle attached to the bottom surface of the vault and offset from the first baffle, the second baffle extending across the width of the interior space;
a second gap between a top of the second baffle and the top surface of the vault, wherein the top of the second baffle is above the bottom of the first baffle;
a first vault section between the first side and the first baffle, the first vault section comprising a vault inlet, wherein a top edge of the vault inlet is positioned above the top of the second baffle;
a second vault section between the first baffle and the second baffle;
a third vault section between the second baffle and the second side; and
a flow conduit positioned within the third vault section and connected to a vault outlet, the flow conduit comprising a flow conduit inlet with a filter, the flow conduit inlet separated from the bottom surface of the vault and positioned below the vault outlet and below the top of the second baffle.

2. The stormwater treatment vault of claim 1, wherein a section of the flow conduit is between the flow conduit inlet and the bottom surface of the vault.

3. The stormwater treatment vault of claim 1, wherein a bottom end of the vault outlet is positioned below the top of the second baffle.

4. The stormwater treatment vault of claim 1, wherein the first baffle comprises a v-notch weir along the bottom of the baffle.

5. The stormwater treatment vault of claim 1, wherein the flow conduit is a pipe.

6. The stormwater treatment vault of claim 1, further comprising a scum baffle offset from and attached to the second baffle on a side of the second baffle facing the first baffle, the scum baffle including a top end above the top of the second baffle and a bottom end below the top of the second baffle.

7. The stormwater treatment vault of claim 6, wherein a bottom end of the vault outlet is positioned below the top end of the scum baffle.

8. The stormwater treatment vault of claim 1, wherein the body comprises a base and a top.

9. A stormwater treatment vault for receiving water from a surface draining area, the vault comprising:
a body defining a top surface, a bottom surface, a first side on one end of a length of the vault, and a second side on an opposite end of the length;
a first section between the first side and a first baffle attached to the top surface, the first baffle extending across a width of the vault and extending toward but not reaching the bottom surface of the vault, the first section comprising a vault inlet;
a second section between the first baffle and a second baffle attached to the bottom surface, the second baffle extending across the width of the vault and extending toward but not reaching the top surface of the vault, wherein a top of the second baffle is above a bottom of the first baffle and below the vault inlet;
a third section between the second baffle and the second side; and
a vault outlet positioned in the third section;
wherein the first baffle comprises a v-notch weir attached to the bottom of the first baffle.

10. The stormwater treatment vault of claim 9, further comprising a flow conduit vertically positioned within the third section and connected to the vault outlet, the flow conduit comprising a flow conduit inlet with a filter, the flow conduit inlet positioned above the bottom surface of the vault but below the top of the second baffle.

11. The stormwater treatment vault of claim 9, wherein the flow conduit is a pipe.

12. The stormwater treatment vault of claim 9, further comprising a scum baffle offset from and attached to the second baffle between the first and second baffles, the scum baffle being partially above and partially below the top of the second baffle, wherein the vault outlet is positioned below a top of the scum baffle such that water passing from the second section to the third section must pass between the scum baffle and the second baffle.

13. The stormwater treatment vault of claim 9, wherein water that enters the first section and passes to the second section will flow below the first baffle, leaving buoyant debris floating within the first section, and water that passes from the second section to the third section will flow up and spill over the second baffle, leaving nonbuoyant debris on the bottom surface in the second section.

14. The stormwater treatment vault of claim 9, wherein the body comprises a base and a top.
